(19) United States
(12) Patent Application Publication
(10) Pub. No.: US 2014/0082470 A1
(43) Pub. Date: Mar. 20, 2014

(54) SPREADTREE HIERARCHY SYSTEM FOR SPREADSHEETS AND RELATED METHODS

(71) Applicants: David Trebas, Irvine, CA (US); William Trout, Surprise, AZ (US); Michael Brown, Colorado Springs, CO (US)

(72) Inventors: David Trebas, Irvine, CA (US); William Trout, Surprise, AZ (US); Michael Brown, Colorado Springs, CO (US)

(73) Assignee: 4CLICKS SOLUTIONS, LLC, Colorado Springs, CO (US)

(21) Appl. No.: 13/623,065

(22) Filed: Sep. 19, 2012

(51) Int. Cl. G06F 17/00

(52) U.S. Cl. 715/217

(57) ABSTRACT

A method of managing a spreadtree hierarchy comprises storing at least one spreadsheet in a network environment accessible to a plurality of users, and storing at least one data object in the network responsive to an edit of the at least one spreadsheet, the at least one data object having a unique ID and data associated with the edit. A spreadtree system comprises an application server configured to operate within a network (Internet or Intranet), and further configured to communicate with a plurality of clients and manage a spreadtree hierarchy. The spreadtree hierarchy comprises a plurality of linked spreadsheets having reference files stored within the network, and a plurality of data objects associated with the plurality of linked spreadsheets. Each data object of the plurality includes a change to at least one cell in at least one linked spreadsheet of the plurality. A method for operating a spreadtree hierarchy system is also disclosed.

### CROSS REFERENCE TO RELATED APPLICATION

This application is related to U.S. patent application Ser. No. 13/444,532, filed Apr. 11, 2012, and entitled “Storing Application Data,” the disclosure of which is incorporated herein by this reference in its entirety.

### TECHNICAL FIELD

Embodiments of the present disclosure generally relate to spreadsheets. More specifically, embodiments of the present disclosure relate to a spreadtree hierarchy for spreadsheets, including a capability for dynamic, enhanced collaboration among individuals in a multi-level hierarchy working on electronic datasets, and related methods.

### BACKGROUND

Spreadsheets have been in use for a considerable length of time. With the advent of microcomputers, spreadsheets became electronic and more user friendly than early paper spreadsheets. Electronic spreadsheets were an improvement over the first paper versions, in part, because of the ease of making entries, revising entries, performing calculations, sorting, etc. As a result, the time for the user was reduced for using the spreadsheet. Because calculations were performed by a computer, rather than by hand, electronic spreadsheets also reduced errors, which were attributed to input errors rather than calculation errors. As a result, electronic spreadsheets became a powerful tool for calculations and organizing data.

FIG. 1 is a simplified view of a conventional electronic spreadsheet 100. The conventional electronic spreadsheet 100 is organized by rows 110 and columns 120. The areas at which rows 110 and columns 120 intersect may be referred to as “cells.” A user may provide an entry into a cell. For example, an entry may include a label (e.g., cells A1, A3, A4, A5, A7, B2), a number (e.g., cells B3, B4, B5), or a formula (e.g., cell B7). In addition to enabling such information to be entered and associated with a cell, the conventional spreadsheet 100 may perform the following additional functions: (1) automatic updating of cells when changes are made, (2) showing formulas at top of the screen in a formula area 130, (3) displaying other relevant information at top of the screen, and (4) allowing splitting of the screen for work on cells far apart from one another. This core functionality has remained the standard for electronic spreadsheets.

The conventional electronic spreadsheet 100 may also be linked to other spreadsheets. For example, one cell of a first spreadsheet may refer to another cell in another spreadsheet. Such references between spreadsheets create a link between the spreadsheets. A spreadsheet having such references has many difficulties associated with sharing the spreadsheet between different users at different locations.

FIG. 2 shows an example of a typical situation in which spreadsheets may be shared between users in a business environment 200. A first user 210 may create and/or update a first spreadsheet 212. The first user 210 may desire to share this spreadsheet within a second user 220 for review or collaboration. The first user 210 may send the first spreadsheet 212 (e.g., via email 205) to the second user 220. The second user 220 may receive the email 205 with an attached copy of the first spreadsheet 212. The second user 220 may wish to view or make changes to the first spreadsheet 212. In order to do so, the second user 220 may create their own second spreadsheet 222 to work from. At this point, the second spreadsheet 222 and the first spreadsheet 212 are identical because the second spreadsheet 222 was created from the copy of the first spreadsheet 212, and no changes have yet to be made. The original first spreadsheet 212, however, remains with the first user 210. The first spreadsheet 212 may include links 213, 214 to reference spreadsheets 214, 216.

One problem that may arise in this situation is that the links 223, 225 (i.e., references) between spreadsheets (not to confused with hyperlinks between web documents) may not function properly because the reference spreadsheets are not present in the second user's 220 computer. The links 223, 225 often do not work because the second user 220 typically needs to have the referenced spreadsheets stored on their computer. Even if the reference spreadsheets were stored on the second user's 220 computer, the reference spreadsheets would need to be stored with the same names and under the same location as the computer that created the first spreadsheet 212 (i.e., identical file, folder, and path names). If the second user 220 does not have the referenced spreadsheets saved in the proper location, the links 223, 225 may not refer to any files, let alone the desired files. Thus, file references in conventional electronic spreadsheets often become corrupted when the conventional electronic spreadsheet is emailed to another computer.

In addition, if multiple users are simultaneously working on copies of the same spreadsheet, changes may be difficult to keep track of, because the users would have to manually keep track of, and merge, the changes themselves. For example, one or both of the users 210, 220 may make changes to their version of the spreadsheet 212, 222. The first user 210 may continue to work on the first spreadsheet 212 and make changes that the second user 220 is not aware of. Similarly, the second user 220 may work on the second spreadsheet 222 and make changes that the first user 210 is not aware of. Thus, different versions of the spreadsheets 212, 222 exist with changes that may need to be merged into a common file, which may be labor intensive. In addition, some of these changes may contradict one another. Additional time would be required to identify these differences and contradictions to determine which change should be accepted. As a result, sharing and collaboration with complex spreadsheets may be labor intensive and error prone. Involving even more users may complicate these problems even more.

There are some web-based spreadsheets currently available (e.g., GOOGLE® Docs Spreadsheet, MICROSOFT EXCEL®). These current web-based spreadsheets offer limited multi-user capability. For example, such current web-based spreadsheets have simply replaced the hard drive or network storage available to a traditional electronic spreadsheet with internet based storage. Connecting a spreadsheet to non-spreadsheet data and enforcing a multi-level hierarchy with multiple access privileges is not available in these products.

Large, multi-level hierarchical organizations traditionally adopt one of two methods for their organizational data needs. They either develop or use traditional database tools. Traditional database tools have the advantage of being very fast for the collection and reporting of information at all levels of the hierarchy; however, they have a disadvantage of lacking in flexibility. Users at different levels cannot customize and link outside data to the relevant portion of their data. It is also very time consuming to make any changes to the system and development, such that maintenance costs may be high. Organizations that use off-the-shelf solutions may have lower development costs, but then lack the same flexibility just mentioned and also have the added difficulty in making any changes. Other organizations opt for spreadsheets that are similar to the conventional spreadsheet systems described above. The advantage of conventional spreadsheets over conventional database tools is that spreadsheets may be more flexible than database tools in both the type of data and links to other data. However, conventional spreadsheets may introduce the other problems described above. For example, the quasi-manual process of collating spreadsheets throughout the hierarchy may create an issue of data latency. Data latency is a factor of how many collations are needed and how long it takes to do each one. Using conventional spreadsheets can be very slow, if not impossible, to quickly gather relevant and timely information. By the time the data is collated at any given level, there is a good chance the data is already out-of-date.

### SUMMARY

An embodiment of the present disclosure includes a method of managing a spreadtree hierarchy. The method comprises storing at least one spreadsheet in a network environment accessible to a plurality of users, and storing at least one data object in the network responsive to an edit of the at least one spreadsheet, the at least one data object having a unique ID and data associated with the edit.

Another embodiment of the present disclosure includes a spreadtree system. The spreadtree system comprises an application server configured to operate within a network, and further configured to communicate with a plurality of clients and manage a spreadtree hierarchy. The spreadtree hierarchy comprises a plurality of linked spreadsheets having reference files stored within the network, and a plurality of data objects associated with the plurality of linked spreadsheets. Each data object of the plurality includes a change to at least one cell in at least one linked spreadsheet of the plurality.

Another embodiment of the present disclosure includes a method for operating a spreadtree hierarchy system. The method comprises updating a network-based reference file for a spreadsheet responsive to a user's edit to the network-based reference file, and automatically updating another user's local version of another spreadsheet linked to the spreadsheet responsive to the user's edit to the network-based reference file.

### BRIEF DESCRIPTION OF THE DRAWINGS

FIG. 1 is a simplified view of a conventional electronic spreadsheet;

FIG. 2 shows an example of a typical situation in which spreadsheets may be shared between users in a business environment;

FIG. 3 is a spreadtree hierarchy of spreadsheets according to an embodiment of the present disclosure;

FIG. 4 is a schematic block diagram of a system for storing and managing a spreadtree according to an embodiment of the present disclosure; and

FIG. 5 is a schematic representation of a timeline for a plurality of data objects created for an entry of a spreadtree.

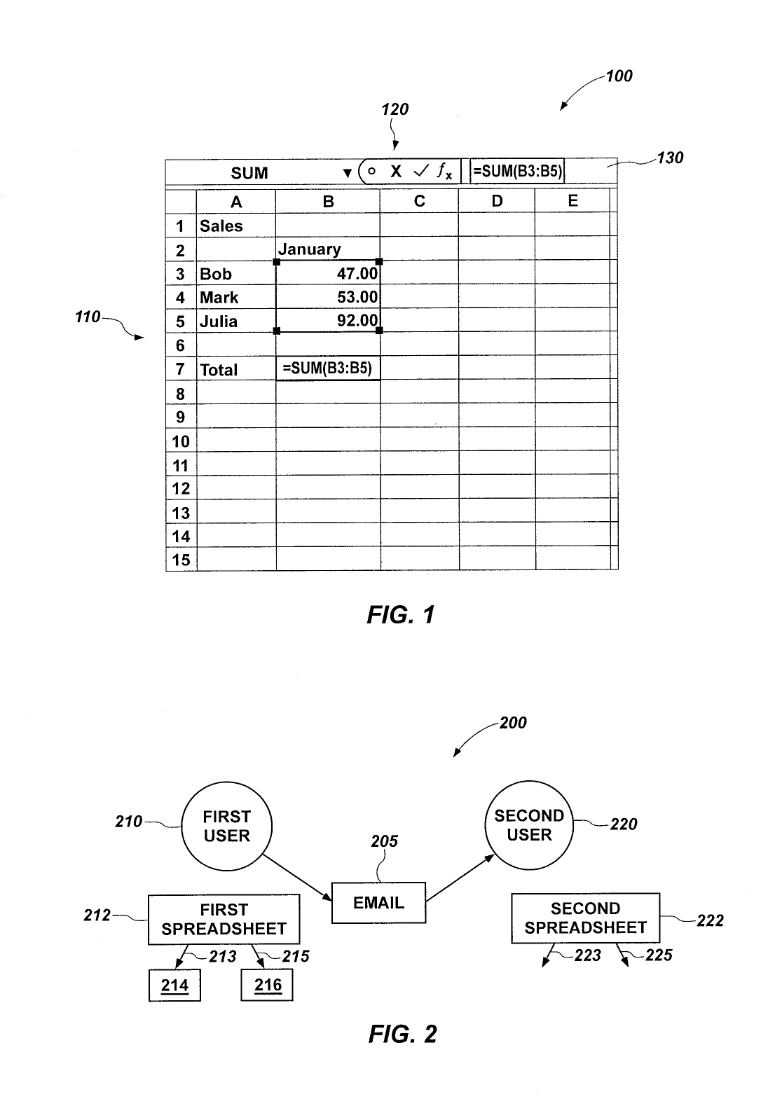

### DETAILED DESCRIPTION

In the following description, reference is made to the accompanying drawings in which is shown, by way of illustration, specific embodiments of the present disclosure. Other embodiments may be utilized and changes may be made without departing from the scope of the disclosure. The following detailed description is not to be taken in a limiting sense, and the scope of the present invention is defined only by the appended claims and their legal equivalents.

Furthermore, specific implementations shown and described are only examples and should not be construed as the only way to implement or partition the present disclosure into functional elements unless specified otherwise herein. It will be readily apparent to one of ordinary skill in the art that the various embodiments of the present disclosure may be practiced by numerous other partitioning solutions.

In the following description, elements, circuits, and functions may be shown in block diagram form in order not to obscure the present disclosure in unnecessary detail. Additionally, block definitions and partitioning of logic between various blocks is exemplary of a specific implementation. It will be readily apparent to one of ordinary skill in the art that the present disclosure may be practiced by numerous other partitioning solutions. Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general-purpose processor, a special-purpose processor, a Digital Signal Processor (DSP), an Application-Specific Integrated Circuit (ASIC), a Field-Programmable Gate Array (FPGA) or other programmable logic device, a controller, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A general-purpose processor may be considered a special-purpose processor while the general-purpose processor executes instructions (e.g., software code) stored on a computer-readable medium. A processor may also be implemented as a combination of computing devices, such as a combination of a DSP and a microprocessor, a plurality of microprocessors, one or more microprocessors in conjunction with a DSP core, or any other such configuration.

Also, it is noted that the embodiments may be described in terms of a process that may be depicted as a flowchart, a flow diagram, a structure diagram, or a block diagram. Although a process may describe operational acts as a sequential process, many of these acts can be performed in another sequence, in parallel, or substantially concurrently. In addition, the order of the acts may be re-arranged. A process may correspond to a method, a function, a procedure, a subroutine, a subprogram, etc. Furthermore, the methods disclosed herein may be implemented in hardware, software, or both. If implemented in software, the functions may be stored or transmitted as one or more instructions or code on computer readable media. Computer-readable media includes both computer storage media and communication media, including any medium that facilitates transfer of a computer program from one place to another.

It should be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed or that the first element must precede the second element in some manner. In addition, unless stated otherwise, a set of elements may comprise one or more elements.

Many of the functional units described in this specification have been labeled as modules in order to more particularly emphasize their implementation independence. For example, a module may be implemented as a hardware circuit comprising custom VLSI circuits or gate arrays, off-the-shelf semiconductors, such as logic chips, transistors, or other discrete components. A module may also be implemented in programmable hardware devices, such as field programmable gate arrays, programmable array logic, programmable logic devices, or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may further be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

Embodiments of the present disclosure include a spreadtree architecture that is a network-based tree of spreadsheets (and other node data) that may be organized into a spreadtree hierarchy. The spreadtree hierarchy may include one or more spreadsheets and/or dataset at each level of the spreadtree hierarchy. Embodiments of the present disclosure further include a spreadtree having an audit trail. The audit trail may include historical data for the spreadtree as a whole, as well as for each cell of each spreadsheet of the spreadtree. Embodiments of the present disclosure further include network-based storage of reference files for the spreadtree including data objects including changes to the spreadsheets as well as a unique ID. The network may further provide memory extension for processing and storing data for the spreadtree. Such a network may include local networks (e.g., intranet) as well as global networks (e.g., Internet, cloud).

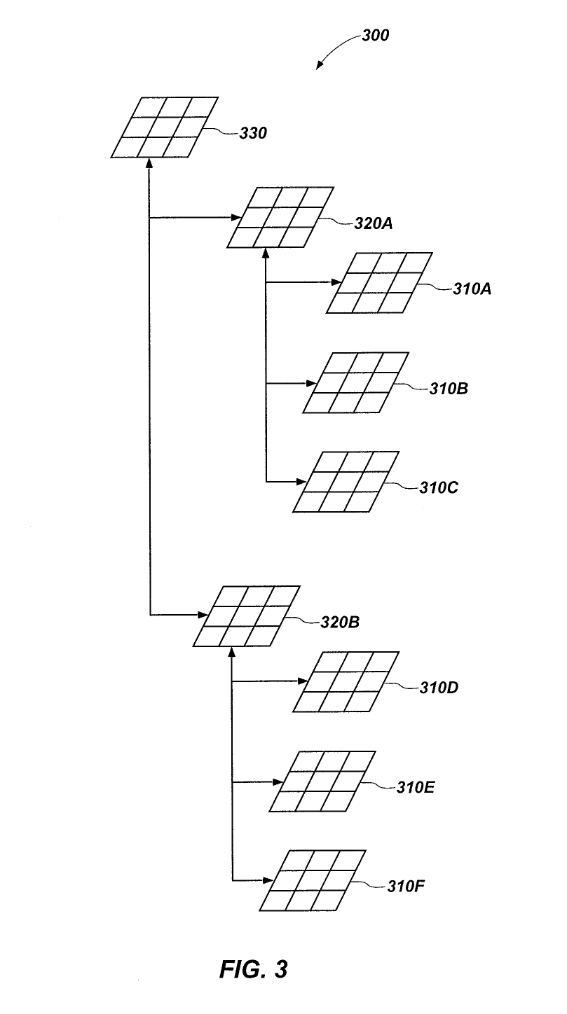

FIG. 3 is a spreadtree hierarchy 300 of spreadsheets according to an embodiment of the present disclosure. The spreadtree hierarchy 300 may include one or more individual spreadsheets 310A-310F, 320A, 320B, 330 that may be configured to be linked to different spreadsheets within the spreadtree hierarchy 300. Such a spreadtree hierarchy 300 of spreadsheets may be referred to herein as a “spreadtree.” An individual spreadsheets 310A-310F, 320A, 320B, 330 or subgroup of spreadsheets 310A-310F, 320A, 320B, 330 may be considered a spreadtree; however, for simplicity the entire spreadtree hierarchy 300 is generally referred to as a spreadtree while the subparts of the entire spreadtree hierarchy 300 are generally referred to as spreadsheets 310A-310F, 320A, 320B, 330. A spreadtree may include a spreadsheet that may be referenced by a higher level spreadsheet, may reference to a lower level spreadsheet within the spreadtree hierarchy 300, or both. Thus, each spreadsheets 310A-310F, 320A, 320B, 330 within the spreadtree hierarchy 300 may, itself, be considered a spreadtree regardless of whether the spreadsheet is at the top level (e.g., spreadsheet 330) of the spreadtree hierarchy 300, the bottom level (e.g., spreadsheets 310A-310F) of the spreadtree hierarchy 300, or an intermediate level (e.g., spreadsheets 320A, 320B) of the spreadtree hierarchy 300.

Embodiments of the present disclosure may include spreadtrees that are linked such that one spreadtree may refer to (e.g., receive data from) another spreadtree. As an example, the spreadsheet 320A may reference the spreadsheets 310A, 310B, 3100. The spreadsheet 320B may reference spreadsheets 310D, 310E, 310F. The spreadsheet 330 may reference spreadsheets 320A, 320B. Thus, the spreadtrees 330, 320A, 320B may each be collated spreadsheets. Thus, because each of the spreadsheets 310A-310F, 320A, 320B, 330 may be configured to refer to another spreadsheet and/or be referred to by another spreadsheet, as well as including other functionality described herein, each of the spreadsheets 310A-310F, 320A, 320B, 330 may be itself considered a spreadtree.

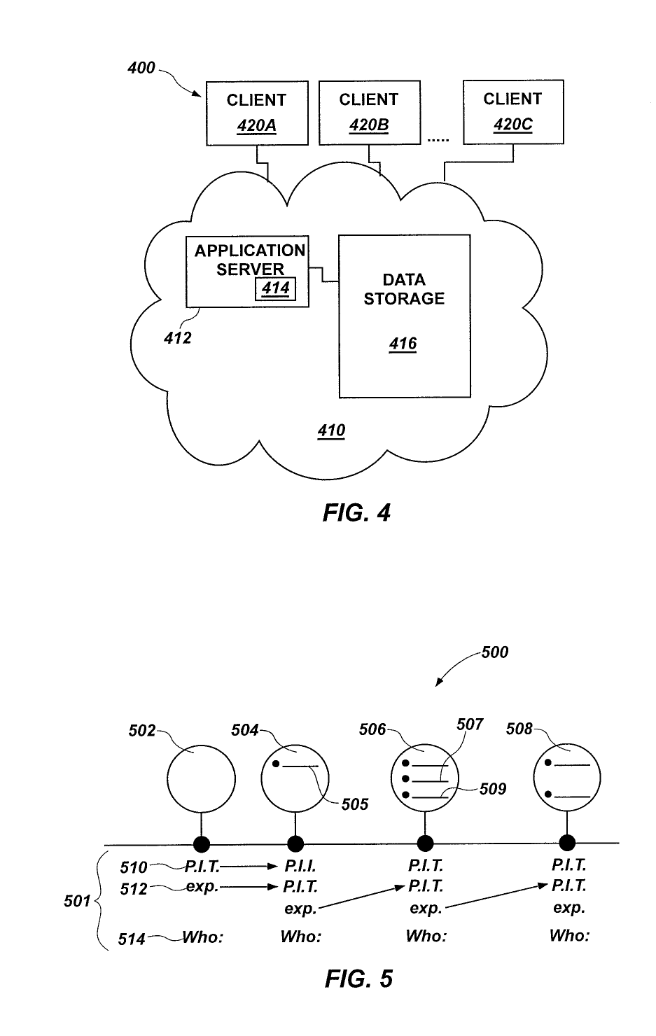

Each of the files for the spreadsheets 310A-310F, 320A, 320B, 330 may be available over a network (FIG. 4). The ability of the spreadsheets 310A-310F, 320A, 320B, 330 to link with each other through a network environment may provide for the ability to build for a community of spreadsheets. Because each of the files for the references and their pathways are stored on the network, the spreadsheets 310A-310F, 320A, 320B, 330 may be accessed by a plurality of users without the need to create static file copies that may later need to be merged with other versions of the file. In addition, having a common location accessible by a plurality of users may ensure that the links between the spreadsheets 310A-310F, 320A, 320B, 330 are properly maintained. As a result, sharing the spreadsheets 310A-310F, 320A, 320B, 330 with other users is a matter of providing the other users with access to the network. As a result, collaborating with a plurality of users may be substantially easier than conventional approaches. In addition, utilizing a network environment may permit storing and processing the spreadtree functions in the network environment rather than the local computer of the user. The network environment generally has more RAM or other available memory than the user's computer possesses.

Each of the spreadsheets 310A-310F, 320A, 320B, 330 may be changed by one or more users that have access and editing privileges to do so. The spreadsheets 310A-310F, 320A, 320B, 330 may be configured such that changing one of the spreadsheets (e.g., spreadsheet 310A) may cause the other spreadsheets (e.g., spreadsheets 320A, 330) that are linked within the spreadsheet hierarchy 300 to be automatically updated. For example, the spreadsheets may be automatically updated that are linked upstream, downstream, and throughout a directed acyclic graph (DAG) of ‘user definable nodes’ where the node types may include, but are not limited to, spreadsheet-like data. As a result, if the spreadsheet 330 includes a calculation that refers to a value in the spreadsheet 310A, the spreadsheet 330 may automatically perform its updated calculation of the data from the spreadsheet 310A responsive to a change in the data. Even if the spreadtree (or a portion of the spreadtree) is being worked on at the same time by a plurality of different users, a change to the spreadsheets 310A-310F, 320A, 320B, 330 by one user may be available to other users of the spreadsheets 310A-310F, 320A, 320B, 330. Thus, each spreadsheets 310A-310F, 320A, 320B, 330 may be a dynamic document that may be changed and updated for each user as opposed to conventional static versions of spreadsheets being worked on simultaneously that are then saved and shared, which require manual updates or other coordination.

In addition, the spreadtree hierarchy 300 may enable individual users and spreadsheets 310A-310F, 320A, 320B, 330 to be assigned to levels within the spreadtree hierarchy 300. The levels may define the access privileges (e.g., viewing, editing, creating, linking, etc.) that a user might have for a spreadsheet having a particular level in the spreadtree hierarchy 300. Thus, a spreadsheet may have a level associated therewith, which may determine which users may view, edit, upload, and/or link to it based on the user's level and associated access privileges.

As an example, the first plurality of spreadsheets 310A, 310B may be assigned a first level, the second plurality of spreadsheets 320A, 320B may be assigned a second level, and the third spreadsheet 330 may be assigned a third level. The assignment of levels to different users to access different levels of the spreadsheets may enable the enforcement of a restricted ability to for the user to make a change to spreadsheets. For example, a user may be restricted to make a change to spreadsheets only at the user's assigned level or lower. For example, a user on a higher level (e.g., third level) may have full access privileges for spreadsheets having an equal or lower level (e.g., first, second, or third level). As another example, a user on a lower level (e.g., first level) may have restricted access privileges to spreadsheet having a higher level (e.g., second or third levels). As a result, the work within a specific level of spreadsheet may be focused and controlled to be viewed and/or edited only by certain users.

Restricted access privileges may also be assigned to levels independently of each other. For example, the user may be able to view (but not edit) some spreadtrees spreadtrees of some levels. In some embodiments, restricted access may include a complete prohibition of access privileges for certain levels of the spreadtrees. Of course, the access privileges described herein may be defined according to the desires of the administrator of the spreadtree hierarchy 300, which may be more restrictive or less restrictive than the access privileges specifically described herein, as the case may be.

Although three levels are shown in FIG. 3, any number of levels are contemplated as embodiments of the present disclosure. In addition, it is contemplated that any number of individual spreadsheets may be included for each level according to the desires of the organization. As a result, a business may use a single spreadtree hierarchy 300 to connect relatively large numbers (e.g., thousands) of spreadsheets and collate the data contained therein to the spreadsheets of the highest level. For example, a business may maintain a spreadtree hierarchy 300 having fifty levels, the highest level representing the owner of the business. The top level of the spreadtree hierarchy 300 may include one spreadsheet, and the remaining forty-nine levels may include hundreds, if not thousands, of spreadsheets.

The spreadtree hierarchy 300 may be configured to allow users on any given level to make file references to spreadsheets on levels below them. Because users at each level may link to the spreadsheets in the levels below them, the spreadsheets only have to be modified, not rewritten. A user at level 25 of the spreadtree does not need to write a new spreadsheet with all of the information from level 24; the user may be able to simply use file references for the information the user needs and submit their information at their level.

In response to a change within a spreadsheet, the spreadtree hierarchy 300 may automatically tabulate data at all levels of the spreadtree hierarchy 300. In other words, a change made at the bottom level of the spreadtree hierarchy 300 may ripple through the spreadtree hierarchy 300 until the spreadsheet at the top level is updated. As a result, once spreadsheets have been arranged at all levels of the spreadtree, information may be constant and current because additional work may not be required by anyone to update the spreadtree after a user updates their information, which may reduce human error. In addition, if human error is made while entering information into the spreadtree, the amount of time to correct the problem in the appropriate location, may also be reduced as a single individual may correct the problem and have that correction automatically affect the entire spreadtree hierarchy 300. As a result, the collation process that many businesses currently struggle with may be improved.

Changes may also be stored in a data object along with the time of the change and the user the effectuated the change. As a result, historical versions of the spreadtree may be recreated for a given point in time on demand. Such a feature may also provide an audit trail for an administrator of the spreadtree hierarchy 300. Such an audit trail may exist for the complete spreadtree hierarchy 300, individual spreadsheets within the spreadtree hierarchy 300, as well as for individual entries (e.g., line items, cells, etc.) within individual spreadsheets. As a result, a user to may view the at least a portion of the spreadtree hierarchy 300 for any point in time and the user may view the username, date, time, and values for any change made to the spreadtree hierarchy 300. Because each cell and every change made in a spreadtree may have an audit trail, it may be determined which user submitted what information.

The audit trail may further enable a user with the ability to drill down or roll up on values, because the historical values of the spreadsheets as well as individual cells are available to the user. To “drill down” the user may start with a final value for a location in a spreadsheet and view each of the previous values and changes that led up to the final value. To “roll up” the user may start with an original value and view each of the changes through later versions of the spreadtree. A “final value” and “original value” are not intended to imply that the starting point for drilling down or rolling up is the absolute last or absolute first value of a particular cell. Rather, a final value may be a value that is an intermediate value that has had previous changes leading up to it, and an original value may be a value that is an intermediate value that has had later changes made to it. In other words, a user may start with a value at any given time and view the changes in the value going forward and/or backward in time. Thus, the user may learn what changes were made to the sheet, what calculations were used, who made the changes, and other similar information for the spreadsheet. The spreadsheet may offer information as to past values as well as how those values came to be, rather than providing only the most recent values as with conventional spreadsheets.

The existence of an audit trail may act as a deterrent for poor user behavior. For example, the user may know that poor behavior will be detectable through the audit trail. In addition, damage caused from poor behavior may be reversible because the spreadtree may be restored to a previous version of itself, because the historical changes are saved rather than being saved over. Thus, the consequence of poor behavior effectively falls on the user who made negative changes to the spreadsheet of the spreadtree hierarchy 300. In addition, another benefit of having such an audit trail may be that the spreadtree hierarchy 300 may be used to assist a neutral third party witness in a court of law.

FIG. 4 is a schematic block diagram of a system 400 for storing and managing a spreadtree according to an embodiment of the present disclosure. The system 400 may include a network 410 that includes an application server 412 and data storage 416. The application server 412 may store and/or perform processing for a spreadtree application 414. The system 400 may further include one or more clients 420A, 420B, 420C that may communicate with the application server 412. The clients 420A, 420B, 420C may be operated by users to access the spreadtree application 414 for creating and/or modifying a spreadtree, which will be described in further detail below.

The network 410 may include software and hardware that enable users to manage and store spreadtree information remotely via the Internet or other network types. The network 410 may include servers, databases, processors, and other types of devices that are not visible to an end-user, but which operate behind the scenes to provide services to the end-user, such as data storage and processing capabilities. For example, the network 410 may include the application server 412 that perfoinis the processing for a spreadtree application 414. The network 410 may further include the data storage 416 configured to store data objects created during operation of the spreadtree application 414. The data storage 416 may be part of the application server 412, on a separate server from the spreadtree application 414, or on one or more separate data storage devices. Depending on the size of the network 410, the application server 414 may include one or more servers, and the data storage devices 416 may include one or more data storage devices 420. Because much of the processing and storage for the spreadtree hierarchy 300 is moved to the network 410, the spreadtrees may have access to more memory for storage and processing than is generally available on the user's computer.

In some embodiments, the network 410 may include a local network, in which the application server 412 and other network components may exist within a firewall of the clients 420A, 420B, 420C. For example, the network 410 may be a local area network (e.g., a local cloud network) or other private network of a business. In some embodiments, the network 410 may be an external network, such that the application server 412 may exist external to the firewall of the clients 420A, 420B, 420C. As a result, the clients 420A, 420B, 420C may communicate outside of their firewall to communicate with the application server 412 and access the spreadtree application 414. For example, the network 410 may include one of a public cloud network, a dedicated private cloud network, and a private cloud network created within a public cloud network.

The clients 420A, 420B, 420C may include various types of electronic devices that typically each include local memory and a processor, which may be configured to access the network 410. For example, the clients 420A, 420B, 420C may comprise an electronic device such as a personal computer, laptop, server, smart phone, tablet, cell phone, personal digital assistant (PDA), or the like. In some embodiments, the clients 420A, 420B, 420C may be configured to access the network 410 through a web application using a browser, such as INTERNET EXPLORER®, SAFARI®, FIREFOX®, GOOGLE CHROME®, or the like.

The spreadtree application 414 may be stored in the application server 412 of the network 410, such that the spreadtree application 414 may be accessed by the plurality of clients 420A, 420B, 420C. The spreadtree application 414 may include instructions stored on a computer-readable medium of the application server 412. When executed by a processor, the instructions of the spreadtree application 414 may be configured to perform one or more of the methods described herein.

The data storage 416 may comprise a data storage database configured to store one or more data objects that are created when a user makes a change to the spreadtree. The term “data object,” refers to a data structure that encapsulates data in a useful format. Typically data objects may be manipulated by a programming language and may be passed from the clients 420A, 420B, 420C to the network 410 for storage or manipulation. One example of a data object as used herein is a JavaScript Object Notation (JSON) object. A JSON object may be a lightweight text-based open standard designed for human-readable data interchange. A JSON object may be derived from JavaScript for representing simple data structures and associative arrays and relationships. Although derived from JavaScript, JSON objects are language independent, because parsers are available for most programming languages. Another example of a data object is a blobject. A blobject is the acronym for binary large object.

The spreadtree application 414 may further include a data storage tool for implementing data storage in the network 410. Generally, the data storage tool may enable data storage in the network 410 that includes a multi-user interface for allowing concurrent data storage, implementing automatic backup by maintaining a historical timeline of previously stored data objects, and/or implementing schema-less data storage that allows for expansive linking of data records and sub-records. The data storage tool may be configured to create new data objects when changes are made to a spreadtree.

The files and the data objects used in the spreadtree may be uploaded into the network 410. The spreadtree file references will function properly even when shared among different users because the files are stored in the network 410 rather than on a user's computer. In other words, spreadtree file references retain their integrity regardless of which of the clients 420A, 420B, 420C accesses the spreadtree because all files are stored at the same location in the network 410 each time the file is accessed. Any referenced files and their pathways are stored on the network 410 and are not specific to any one computer. The networked-stored file references and audit trail make it unnecessary to email a spreadtree when sharing the spreadtree with higher ranking colleagues. Spreadtree hierarchies have reference files stored in a network environment.

The pathway may point back to the appropriate network location, and file references may function properly. The audit trail integrated into each spreadtree makes it possible for users to see previous values, how they changed, and who changed them. Because previous changes are saved, previous versions of the spreadtree may be recreated and made available over time.

In addition, spreadtrees can access additional RAM using the network 410 than if the processing is performed locally by the individual client 420A, 420B, 420C. Having additional RAM from the network 410 may be particularly beneficial for spreadtrees because the spreadtree may connect several spreadsheets (along with a full audit trail).

FIG. 5 is a schematic representation of a timeline 500 for a plurality of data objects 502, 504, 506, 508 created for an entry of a spreadtree. As discussed above, each spreadtree may have an audit trail associated therewith. In addition, each individual cell of each spreadtree may have an audit trail associated therewith. The audit trail associated may include the timeline 500 of the plurality of data objects 502, 504, 506, 508. The timeline 500 may record information, such as, the user, date, and time of every change made to any file or document, along with what the substance of the change was.

Each data object 502, 504, 506, 508 may be created by the spreadtree application 414 (FIG. 4) responsive to a change of the entry in the spreadtree. An entry of the spreadtree may include a sheet, a portion of a sheet, an individual cell, a group of cells, or other area as desired for defining as having its own data object. For example, the first data object 502 is an original version of the data object for the entry of the spreadtree. Subsequent changes to the spreadtree may cause the second data object 504, the third data object 506, and the fourth data object 508 to be created. Thus, when the user modifies an entry, the previous data object (e.g., 502) is not replaced or deleted, but a new version of the data object (e.g., 504) is created with the edits, and the previous version (e.g., 502) continues to be stored for future reference. The result is a timeline (i.e., history) of each data object that provides a backup of every entry change, which may protect against users from accidentally or maliciously deleting data. As a result, the changes for the previous states of the spreadtree are saved and can easily be retrieved.

When the data objects 502, 504, 506, 508 are created, each data object 502, 504, 506, 508 may be assigned a unique ID 501. Each unique ID 501 may include information regarding the change. Using the first data object 502 as an example, the unique ID 501 may include a timestamp 510 and an identification of the user 514 who created the first data object 502. The unique ID 501 may also include an expiration 512 of the first data object 502 as well as other user defined criteria. The expiration 512 of the first data object 502 may be left blank until the creation of a new data object (e.g., second data object 504) for the entry of the spreadtree (i.e., a change has been made). When the second data object 504 is created (e.g., data 505 is added), a second unique ID for the second data object is assigned to the second data object 504. The second unique ID may include similar information, such as the timestamp for the change, expiration, an indication of the person who created the second data object 504. The original timestamp 510 for the first data object 502 may be retained by the second unique ID (and other subsequent IDs). The timestamp for the change in the second data object 504 may be approximately the time of the expiration of the first data object 502. As subsequent changes to the entries of the spreadtree are made (e.g., data 507, 509 is added, data 507 is deleted, etc.), additional data objects 506, 508 may be created with similar unique IDs. Thus, when a user edits (e.g., add to, change, delete, etc.) entries of the spreadtree, the user's name becomes connected to the change, which connection may discourage inappropriate use of level access privileges.

Once the unique ID 501 is assigned to a data object, each data object 502, 504, 506, 508 may be stored in a database with its unique ID 501. Thus, instead of replacing the first data object 502, the first data object 502 remains stored with its unique ID 510 and the new second data object 504 becomes the most current version of the data object and is identified by its own unique ID. Each time a new version of the data object is created (in response to a modification of data), a data backup module of the spreadtree application 414 may maintain of the previous versions of the data object in a database for future reference or restoration. The database may include a map associating the unique IDs with the corresponding changes in the data objects. The unique IDs may indicate the points in time on the timeline 500 that the data objects were created, expired, as well as information regarding the user involved in the creation of the particular data object. Further detail regarding the data objects, including resolving conflicts of changes made near the same time, is described in U.S. patent application Ser. No. 13/444,532, filed Apr. 11, 2012, and entitled “Storing Application Data,” the disclosure of which is incorporated herein by this reference in its entirety.

By saving the data objects 502, 504, 506, 508, essentially only the changes to the spreadtree are being saved rather than full copies of the entire spreadtree file. In other words, the data that is changed in the particular entry of the spreadtree is saved.

The data objects 502, 504, 506, 508 may be referenced by data calls and operations received from one or more clients 420A-420C. By default, the spreadtree application 414 returns the latest version of any data object of the spreadtree in response to a data retrieval request. Thus, when a user opens the spreadtree, the spreadtree application 414 may query the unique IDs to obtain the data objects for each entry of the spreadtree for creating the most up-to-date version of the spreadtree. In other words, when a spreadtree is opened, the entire file does not have to be sent back and forth between the network and the user's computer. The user's computer may query the data objects and determine which data objects have since expired due to a change to the spreadtree. As a result, only the new data objects associated with the new changes need to be retrieved for recreating the spreadtree the user's computer. Thus, the spreadtree reconstruct the data to present user with the most current version of information to user's computer. As the user modifies the spreadtree, new data objects may be created with their unique IDs. These new data objects are stored in data storage 416 and are retrieved by other users when accessing the spreadtree application 414. As a result, the pathways are maintained between different users through the network 410, and additional users may likewise see the most up-to-date version of the spreadtree without the need for manually merging multiple files or informing each other of changes made.

If two users are working on the spreadtree simultaneously, an entry may be changed by one of the users that may impact the other user. For example, each user may be working on the same spreadsheet, or a spreadsheet that is linked and may be impacted by the change. In such an event, a new data object may be created for the entry that has a unique ID that is later in time than all other data objects for that entry. The spreadtree application 414 may be further configured to recognize that a new data object has been created, and automatically notify other users of the modification while they are working on the spreadtree. As a result, each user may have an up-to-date version (e.g., within seconds) of the spreadtree even during simultaneous collaboration of multiple users. Such automatic updating may include updating the spreadtree and/or notifying the users who are working on the same level of the spreadtree in the hierarchy. In addition, such automatic updating may include updating the spreadtree and/or notifying the users who are working on different (e.g., higher) levels of the spreadtree in the hierarchy. In some embodiments, users who have access privileges that are of a higher level than the user making the change may be presented with the option to accept or reject the change. For example, a user at level one may make a change to an entry of a spreadtree of level one. During this time, a user at level five may be working on a spreadtree on level five that refers to the spreadtree of level one. The level five user may be notified of the change, and may further decide whether or not the change is to be saved.

In addition to automatically updating the spreadtree responsive to changes by a user among a plurality of users, the data objects and their associated unique IDs may enable creating a spreadtree at a given point in time on demand. The user may desire to see the version of the spreadtree for a given date. For example, the user may enter the desired date, and the spreadtree application 414 may query the database of data objects, using the timestamps for creations and or expiration to determine which data objects were active on the desired date for each entry of the spreadtree. Thus, a complete spreadtree for a given date may be created rather than relying solely on the existence of full static versions saved as backup copies as with conventional spreadtrees, which backup copies may not be the version on the desired date. Not only may complete spreadtrees be recreated for a given date, individual entries or groups of entries may also be queried to provide a value of the entry for a given date. The user may also have the option to restore the data object to a previous condition, if desired.

In addition, the data objects and their associated unique IDs may enable rolling forward and backward in time for the user to view the changes in the spreadtree or an entry thereof over time. For example, the user may start at a given point in time and move forward or backward in time to view the changes in the spreadtree. In some embodiments, the user may isolate an individual entry or groups of entries of the spreadtree to view the changes in such a portion of the spreadtree over time. At each instance of moving forward or backward in time, the spreadtree application 414 may query the database to identify and open the data objects that fall within the timeline at the given point in time. Thus, the exact spreadtree or cell value is retrieved and re-created from the data objects and not just a copy of a static snapshot of a spreadsheet. In addition to viewing the changes in the values of the entries, the edits may also be associated with the user that made the changes.

While certain illustrative embodiments have been described in connection with the figures, those of ordinary skill in the art will recognize and appreciate that embodiments of the invention are not limited to those embodiments explicitly shown and described herein. Rather, many additions, deletions, and modifications to the embodiments described herein may be made without departing from the scope of embodiments of the invention as hereinafter claimed, including legal equivalents. In addition, features from one embodiment may be combined with features of another embodiment while still being encompassed within the scope of embodiments of the invention as contemplated by the inventor.

What is claimed is:

1. A method of managing a spreadtree hierarchy, the method comprising:
storing at least one spreadsheet in a network environment accessible to a plurality of users; and
storing at least one data object in the network responsive to an edit of the at least one spreadsheet, the at least one data object having a unique ID and data associated with the edit.

2. The method of claim 1, further comprising storing at least one additional data object in the network responsive to another edit of the at least one spreadsheet, wherein storage of the at least one data object is maintained.

3. The method of claim 2, further comprising storing a plurality of spreadsheets in the network environment, the plurality of spreadsheets being linked with the at least one spreadsheet in a spreadtree hierarchy.

4. The method of claim 3, further comprising automatically updating at least one of the plurality of spreadsheets responsive to the edit of the at least one spreadsheet.

5. The method of claim 4, further comprising notifying a user of one of the plurality of spreadsheets that the at least one spreadsheet has been edited and prior to saving the edit.

6. The method of claim 2, further comprising recreating the at least one spreadsheet using a plurality of data objects.

7. The method of claim 6, wherein using the plurality of data objects includes using the plurality of data objects based on a most up to date data object for each cell of the at least one spreadsheet.

8. The method of claim 6, wherein using the plurality of data objects includes using the plurality of data objects based on active data objects for each cell of the at least one spreadsheet for a selected prior date.

9. A spreadtree system, comprising:
an application server configured to operate within a network, and further configured to communicate with a plurality of clients and manage a spreadtree hierarchy, the spreadtree hierarchy comprising:
a plurality of linked spreadsheets having reference files stored within the network; and
a plurality of data objects associated with the plurality of linked spreadsheets, each data object of the plurality including a change to at least one cell in at least one linked spreadsheet of the plurality.

10. The spreadtree system of claim 9, wherein the change corresponds to a group of cells in the at least one linked spreadsheet of the plurality.

11. The spreadtree system of claim 9, wherein the network includes a local network including the application server and other network components configured to communicate with the plurality of clients within a firewall of the plurality of clients.

12. The spreadtree system of claim 9, wherein the network includes an external network including the application server and other network components configured to communicate with the plurality of clients external to a firewall of the plurality of clients.

13. The spreadtree system of claim 9, wherein the application server is further configured to manage an audit trail for the plurality of linked spreadsheets, the audit trail including a plurality of data objects associated with prior changes to the at least one cell.

14. The spreadtree system of claim 13, wherein the each of the plurality of data objects are associated with a unique ID including a time stamp for creation of the data object and an identifier for a user that created the data object.

15. The spreadtree system of claim 9, wherein the plurality of linked spreadsheets includes a plurality of linked spreadsheets having different levels that may be accessed by different users having different access privileges according to an assigned level to the different users.

16. A method for operating a spreadtree hierarchy system, the method comprising:
updating a network-based reference file for a spreadsheet responsive to a user's edit to the network-based reference file; and
automatically updating another user's local version of another spreadsheet linked to the spreadsheet responsive to the user's edit to the network-based reference file.

17. The method of claim 16, wherein updating the network-based reference file includes creating a new data object including data from the user's edit while maintaining an old data object including data from a user's previous edit.

18. The method of claim 16, further comprising displaying an audit trail of old data objects associated with the spreadsheet.

19. The method of claim 18, wherein displaying an audit trail includes drilling down through the old data objects backward in time.

20. The method of claim 18, wherein displaying an audit trail includes rolling up through the old data objects forward in time.
